(19) United States
(12) Patent Application Publication
(10) Pub. No.: US 2009/0116021 A1
(43) Pub. Date: May 7, 2009

(54) Method and apparatus for determining composition and concentration of contaminants on a film encapsulated in a plasma display panel

(76) Inventor: Jeffry Mark Bulson, Hopewell Junction, NY (US)

Correspondence Address: MCDERMOTT WILL & EMERY LLP, 600 13TH STREET, NW, WASHINGTON, DC, 20005-3096, US

(21) Appl. No.: 12/285,462

(22) Filed: Oct. 6, 2008

Related U.S. Application Data
(60) Provisional application No. 60/977,836, filed on Oct. 5, 2007.
(60) Provisional application No. 60/960,717, filed on Oct. 11, 2007.

(51) Int. Cl. G01N 21/55

(52) U.S. Cl. 356/445

(57) ABSTRACT

The instant disclosure describes a method for determining composition or concentration of contaminants on a film encapsulated inside a plasma display panel. The method further includes steps of transmitting a light beam through an internal reflection element into the substrate and a film coupled to a surface of the substrate to determine composition or concentration of contaminants formed on the film, receiving the light beam, reflected back from the surface of the film, through a second internal reflection element, and analyzing the light beam received through the second internal reflection element to determine the composition or the concentration of contaminants on the surface of the film.

### CLAIM OF PRIORITY

This application claims priority under 35 USC §119(e) to U.S. Provisional Patent Application Ser. No. 60/977,836, filed on Oct. 5, 2007 and U.S. Provisional Patent Application Ser. No. 60/960,717, filed on Oct. 11, 2007. The entire content of these applications is hereby incorporated by reference.

### TECHNICAL FIELD

The present invention relates to a plasma display panel and more specifically, to a technique for determining composition and concentration of contaminants on a film encapsulated in a plasma display panel.

### BACKGROUND

A plasma display panel (PDP) displays images by exciting a phosphor substance with ultraviolet light generated by a gas discharge to generate light emission. In general, a PDP is composed of a front panel and a back panel. The front panel includes, in part, display electrodes including scanning electrodes and sustain electrodes, a dielectric layer covering the display electrodes, and a protective layer further covering the dielectric layer, on a substrate made of glass or the like. The back panel includes, in part, a plurality of address electrodes orthogonal to the display electrodes, a dielectric layer covering the address electrodes, and partition walls, or ribs, on the dielectric layer. The trough formed by the ribs is filled with a phosphor layer. Arranging the front panel and the back panel so as to face each other forms a discharge cell at the intersection of the display electrode and the data electrode.

Such a PDP offers a high-speed display as compared with liquid crystal panels. In addition, it features a wide viewing angle, easy scaling to large size, and a high-quality image owing to its self-luminous properties. It is widely used in various applications, particularly for a display device in a public place where many people gather, and for enjoying a large-screen image at home.

As noted above, such PDPs include a plurality of films stacked on top of each other. During the manufacturing process, which includes exposure to room air, the films (e.g., a protective layer containing MgO) may become contaminated with contaminants such as, for example, water, which could reduce the life time and quality of the PDPs. Therefore, there is a need to detect the presence of such contaminants on the films in a completed panel and reduce their concentration and/or eliminate them in the manufacturing process.

Traditionally, Fourier Transform Infrared (FTIR) spectroscopy is used to detect molecular species in a sample by measuring the absorption spectrum for a sample of unknown composition and comparing this sample spectrum to the absorption spectra of reference or known compounds/species. Transmission spectroscopy is useful for bulk materials with high transmission properties. In order to measure trace quantities of a substance or to measure films, especially very thin films, a multiple internal reflection method is often used to improve sensitivity.

The total internal reflection FTIR measurement method relies on the coupling, usually multiple times for multiple reflection configurations, of infrared light with a sample placed in intimate contact with an internal reflection element (IRE). The use of IREs to facilitate total internal reflection for FTIR spectroscopy of films is well understood and techniques incorporating IREs are widely used. IREs generally fall into two major categories. The first is suitable for the measurement of gases, liquids, or mixtures of gases in liquids. The second is suitable for the measurement of solid films.

In the first category, the IRE is either formed into a vessel (e.g., sample cell) to accept the sample gas or liquid, as in the devices described in U.S. Pat. Nos. 4,602,869 or 5,035,504, or the IRE is constructed such that it operates when submerged in the sample gas or liquid. This latter type is further subdivided into double- and single-ended devices.

A double-ended IRE is a light tube designed such that the infrared light enters the middle of the tube at one end and exits at the opposite end, and the sample gas or liquid surrounds the outside of the tube. Examples of IREs of this type are described in U.S. Pat. Nos. 4,988,195, 5,170,056, 5,220,401, 5,452,083, and 5,608,518. A single-ended IRE is a light tube with one end configured to reflect the incident infrared light such that the light exits the IRE at the same end that it enters. Examples of these types of devices are described in U.S. Pat. Nos. 5,051,551, 5,185,640, 5,459,316, and 5,991,029. In this category, the incident infrared beam propagates down the IRE and reflects off of the IRE-sample interface.

In the second category, suitable for solid films, the film must be pressed directly against the IRE with significant force to make intimate contact with the IRE, usually using a clamping device like a screw clamp. Examples of these types of IREs include U.S. Pat. Nos. 5,965,889, 5,172,182, and 6,141,100. Complete sample assemblies of this type are described in U.S. Pat. Nos. 5,210,418 and 5,308,983.

In either of the categories described above, the IRE is fabricated from a foreign material, typically ZnSe, AMTIR (AsSeGe glass), Ge, Thallium Bromoiodide KRS-5 (TlBr·TlI), ZnS, CdTe, sapphire (Al₂O₃), ZrO₂, or diamond (C), depending on the application. For either category, the detection of the FTIR spectrum of the sample material depends on the sample material being in direct contact with this foreign IRE. Therefore, these methods are not suitable for measuring contaminants that are formed on inaccessible films fully encapsulated inside a PDP, forming a sealed vacuum tube. Furthermore, even if access was possible by, for example, breaking the PDP, these methods require that the film be pressed directly against the IRE with significant force which may damage the film. Furthermore, opening the PDP possibly exposes the film to more contaminants (e.g., water) in the room and, thereby invalidating the measurements.

Accordingly, there is a need for a method that allows measurement of contaminants on films that are fully encapsulated in a PDP.

### SUMMARY

The instant application is applicable, for example, to systems with internal surfaces where trace chemical analysis, including composition and concentration, is required. The following techniques can be applied to systems where no convenient access to the analyte exists, for example, if it is separated from the instrumentation by a transparent substrate. One example of such a case, and the motivation for the development of this method, is the measurement of water contamination on MgO films encapsulated in plasma display panels.

In one general aspect, the instant application provides a method for determining composition or concentration of contaminants on a film encapsulated inside a plasma display panel. The method includes steps of applying an index matching liquid on a first surface of a substrate of a plasma display panel and optically coupling a first and a second internal reflection element to the applied index matching liquid. The method also includes steps of transmitting a light beam through the first internal reflection element into the substrate and a film coupled to a second surface of the substrate to determine composition or concentration of contaminants formed on the film; receiving the light beam, reflected back from the surface of the film, through the second internal reflection element; and analyzing the light beam received through the second internal reflection element to determine the composition or the concentration of the contaminants on the surface of the film.

Implementations of the above general aspect may include one or more of the following features. For example, the step of analyzing the light beam may include analyzing the light beam to measure concentration of water on the surface of the film. Alternatively or additionally, the step of analyzing the light beam may include analyzing the light beam to measure concentration of water at the interface between the underside of the film and the surrounding environment. The surrounding environment may include a Ne/Xe gas mixture. The step of transmitting the light beam may include transmitting an infrared beam.

In one implementation, the transmitted light beam may be reflected off the interface between the underside of the film and the surrounding environment and may be transmitted out through the substrate, the index matching liquid and the second internal reflection element. The second internal reflection element may be separated from the first internal reflection element such that the reflected light beam is transmitted out after a single bounce. Alternatively or additionally, the second internal reflection element may be separated from the first internal reflection element such that the reflected light beam is transmitted out after multiple bounces. The first and second internal elements may include a hemi-cylindrical shape. Alternatively, the first and second internal elements may include a near-quarter-cylindrical shape. Alternatively, the first and second internal elements may include a hemi-spherical shape. Alternatively, the first and second internal elements may include a near-quarter-spherical shape.

In another implementation, the step of transmitting the light beam through the first internal reflection element may include transmitting a light beam through the first internal reflection element at an incident angle greater than a critical angle to enable reflection of the transmitted light beam from the bottom surface of the film. The critical angle is substantially equal to and defined by the arcsine of the ratio of the index of refraction of a medium below the film to the index of refraction of the film. The medium below the film may consist of a Ne/Xe gas mixture. The film may include a dielectric layer or a protective layer. The first surface and second surface of the substrate may be opposite to each other.

In another general aspect, the instant application describes another method for determining composition or concentration of contaminants on a film encapsulated inside a plasma display panel. The method includes the steps of applying an index matching liquid on a first surface of a substrate of a plasma display panel and coupling an internal reflection element to the applied index matching liquid. The method also includes steps of transmitting a light beam through the internal reflection element into the substrate to determine composition or concentration of contaminants formed on a second surface of the substrate, receiving the light beam, reflected back from the second surface of the substrate, through the internal reflection element, and analyzing the light beam received through the internal reflection element to determine the composition or the concentration of the contaminants on the second surface of the substrate.

Implementations of the above general aspect may include one or more of the following features. For example, the step of analyzing the light beam may include analyzing the light beam to measure concentration of water on the second surface of the substrate. The transmitted light beam may be reflected back from the second surface of the substrate and may be transmitted out through the substrate, the index matching liquid and the internal reflection element. The transmitted light beam may be transmitted into and out of the substrate via a single bounce. Alternatively or additionally, the transmitted light beam may be transmitted into and out of the substrate via multiple bounces. The internal reflection element may include a hemi-cylindrical shape, a near-quarter-cylindrical shape, a hemi-spherical shape, or a near-quarter-cylinder shape.

The step of transmitting the light beam through the internal reflection element may include transmitting a light beam through the internal reflection element at an incident angle greater than a critical angle to enable reflection of the transmitted light beam from the second surface of the substrate. The critical angle is substantially equal to the arcsine of the ratio of the index of refraction of a medium below the substrate to the index of refraction of the substrate. The medium below the substrate may include a Ne/Xe gas mixture.

Implementations of the described techniques may include hardware, a method or process, or computer software on a computer-accessible medium.

The foregoing method is suitable for determining composition and concentration of contaminants that are formed on films fully encapsulated inside a PDP. Unlike the methods described in the background section, the foregoing method does not require breaking the PDP to measure contaminants on films fully encapsulated inside the PDP. That is, the foregoing method enables measuring contaminants on films of completed units, thereby preventing shipment of faulty units. Additionally and unlike the methods described in the background section, the foregoing method does not damage the films by applying significant force thereto. Furthermore, the foregoing method reduces exposures of the films to the contaminants (e.g., water), thereby resulting in more accurate measurements.

The details of one or more implementations are set forth in the accompanying drawings and the description below. Other features will be apparent from the description and drawings, and from the claims.

### BRIEF DESCRIPTION OF DRAWINGS

FIG. 1 illustrates a perspective sectional view showing an example of a general makeup of a PDP.

FIG. 2 illustrates an apparatus for measuring composition and/or concentration of contaminant species on a film that is fully encapsulated inside the PDP.

FIG. 3 illustrates an incident angle of an infrared beam that is transmitted through a first hemi-cylinder IRE, a substrate, and a film without bouncing back.

FIG. 4 illustrates an incident angle of an infrared beam that is transmitted through a first hemi-cylinder IRE, a substrate, and a film and is bounced back from the bottom surface of the film.

FIG. 5 illustrates the index of refraction for various compounds.

FIG. 6 illustrates the transmittance for various compounds.

FIG. 7 illustrates a commercial FTIR bench with a transmission accessory in the sample compartment.

FIG. 8 illustrates one example of a variable angle reflectance accessory called a “Seagull™ accessory,” which is well-known in the art.

FIG. 9 illustrates a sample holder, designed to hold miniature PDPs in the Seagull™ accessory, to apply pressure on the miniature PDP to produce a repeatable force between the PDP substrate and the foreign IREs also mounted in this device, and to position the PDP/foreign IREs to properly intersect the infrared beam at the angle set in the Seagull™ accessory.

FIG. 10 illustrates two examples of sealed plasma display panels positioned by the sample holder illustrated by FIG. 9 to properly focus the infrared beam on the sample surface of the respective plasma display panels.

FIG. 11 illustrates absorption spectra results for three sample PDPs.

FIG. 12 shows an exemplary test matrix used by the instant application to determine the dependence of absorbance on incidence angle, number of bounces, and polarization.

FIG. 13 illustrates total internal reflection absorbance spectra for a 40 degree incident angle, 1-bounce, and no polarization for five sample PDPs.

FIG. 14 illustrates total internal reflection absorbance spectra for a 50 degree incident angle, 1-bounce, and no polarization for five sample PDPs.

FIG. 15 illustrates total internal reflection absorbance spectra for a 40 degree incident angle, 2-bounces, and no polarization for five sample PDPs.

FIG. 16 illustrates total internal reflection peak absorbance at 3,700 cm⁻¹ as a function of incidence angle and number of bounces (1 and 2 bounces) with no polarization.

FIG. 17 illustrates total internal reflection peak absorbance at 3,700 cm⁻¹ as a function of incidence angle and polarization under a single bounce condition.

FIG. 18 illustrates absorption spectra for samples exposed to decreasing levels of water concentration for a 50 degree incidence angle, 1-bounce, and p-polarization.

FIG. 19 illustrates peak absorbance at 3,700 cm⁻¹ as a function of H₂O exposure level for controlled and uncontrolled exposure panels for a 50 degree incidence angle, 1-bounce, and p-polarization.

### DETAILED DESCRIPTION

In one implementation, the application describes a method of measuring low concentrations of contaminant species on films fully encapsulated in thick substrate material. The method is an extension of the Total Internal Reflection Fourier Transform Infrared Spectroscopy method where the internal reflection element is extended from a foreign IRE through a thick substrate material coupled to the film. The film to be measured is on the side of the substrate opposite to that of the foreign IRE. The optical coupling between these two elements (foreign IRE and the thick substrate) is achieved with an index matching liquid (e.g., Fluorolube S-30).

In one particular example, the method enables measuring the concentration of water contamination on MgO films in PDPs. To provide context for this method, first different parts of a PDP are described, and then the manner in which the method is used to measure the concentration of contaminants on films is described.

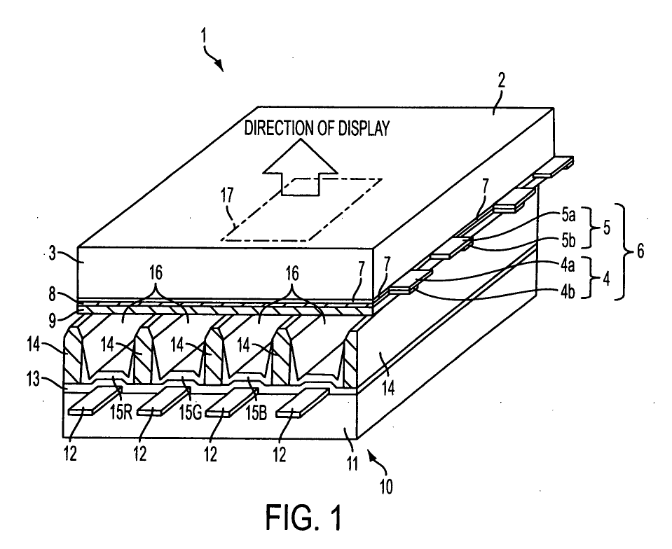

FIG. 1 is a perspective sectional view showing an example of a general makeup of a PDP. Front panel 2 of PDP 1 has display electrode 6 including scanning electrode 4 and sustain electrode 5 formed on a main surface of substrate 3, which is smooth, transparent, and an electrical insulator, typically made of glass.

Front panel 2 often includes a light-impervious layer 7 provided between display electrode 6 and another adjacent one, dielectric layer 8 covering display electrode 6 and light-impervious layer 7, and also protective layer 9 covering dielectric layer 8. In one example, the protective layer 9 consists of MgO. Scanning electrode 4 and sustain electrode 5 are structured so that bus electrodes 4b and 5b are laminated on transparent electrodes 4a and 5a, respectively, made of a highly-conductive material such as a metallic material, in order to reduce electrical resistance. Light-impervious layer 7 shields white light reflected off of a phosphor layer (described later) when non-emitting, effectively improving contrast.

Back panel 10 has address electrode 12 formed on a main surface of substrate 11, which is smooth, transparent, and an electrical insulator, and is typically made of glass; dielectric layer 13 covering the address electrode 12; partition wall 14 arranged at a position corresponding to between address electrode 12 and another adjacent one, on dielectric layer 13; and phosphor layers 15R, 15G, and 15B, between the partition wall 14 and another adjacent one.

Front panel 2 and back panel 10 are arranged facing each other across partition wall 14, so that display electrodes 6 and address electrodes 12 are orthogonalized, and the peripheries of front panel 2 and back panel 10 are sealed with a glass sealing material. In discharge space 16 formed between front panel 2 and back panel 10, a discharge gas (e.g. 5% Ne, balance Xe) is encapsulated at sub-atmospheric pressures (e.g., 66.5 kPa or 500 Torr). The intercept of display electrodes 6 and address electrode 12 in discharge space 16 works as discharge cell 17 (a unit of light-emitting region).

As noted above, PDP 1 includes films such as, for example, dielectric layer 8 which is fully encapsulated within the PDP. In one implementation, films such as, for example, dielectric layer 8 get contaminated with water when exposed to room air. This contamination reduces the quality and life of the PDP. Therefore, it is necessary to measure the level of such contamination in a fully encapsulated PDP to determine if there are any contaminants in the manufactured panel. If so, the manufacturing process can be reviewed and/or revised to determine where the contaminants are occurring and how to eliminate them so that future PDPs produced by the same process do not include the contaminants.

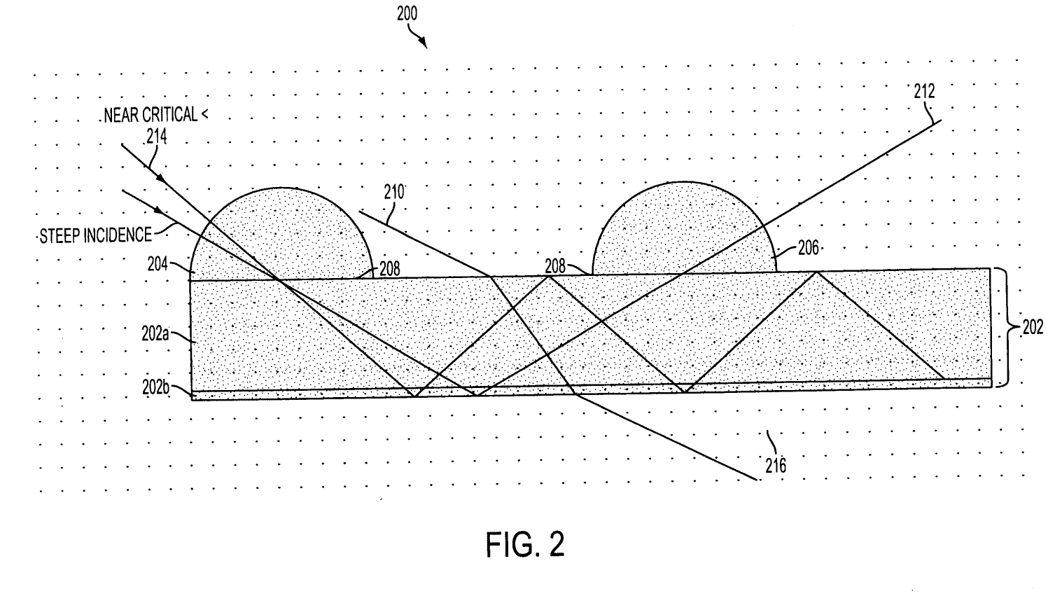

FIG. 2 illustrates an apparatus 200 for measuring concentration of contaminant species on a film that is fully encapsulated inside the PDP. The apparatus 200 includes a PDP front panel 202, a first hemi-cylinder IRE 204, a second hemi-cylinder IRE 206, and an index matching liquid 208. Front panel 202 is similar to front panel 2 illustrated in FIG. 1. However, for the sake of simplicity and brevity of description, all the elements of front panel 202 are not shown in FIG. 2. Front panel 202 includes substrate 202a and a film 202b (e.g., dielectric layer), which are similar to substrate 3, and dielectric layer 8 illustrated in FIG. 1. In one example, substrate 202a is made of glass and the film 202b is made of dielectric glass.

The film 202b may get contaminated with material such as water. To detect such contamination on film 202b, first and second hemi-cylinder IREs 204, 206 are coupled to substrate 202a and act as a foreign IRE. In one example, the first and second hemi-cylinder IREs 204, 206 are made of sapphire with index of refraction equal to 1.70 and are used to measure the level of contaminants on film 202b on the other side of the substrate 202a. The substrate 202a, in one example, is 1.8 mm thick PP-8 soda lime glass with index of refraction equal to 1.48. Optical coupling between the first and second hemi-cylinder IREs 204, 206 (e.g., foreign IREs) and substrate 202a is achieved with index matching liquid 208. The index matching liquid 208 may include a specific type of mineral oil, such as, for example, Cargille Type 50350. Alternatively, the index matching liquid 208 may be replaced with Fluorlube S-30 due to its improved transmittance in the 2,500-4,000 cm⁻¹ band, if this is the band of interest to detect the desired contaminant. Other suitable index matching liquids may also be utilized.

As illustrated in FIG. 2, the incident light beam (e.g., infrared beam) is transmitted through the first hemi-cylinder IRE 204, the index matching liquid 208, the substrate 202a, and film 202b. The object of this measurement is the surface of the film 202b. In principal, however, film 202b is not necessary, and the surface of the substrate 202a itself, opposite to the foreign IRE 204, may simply be measured. Alternatively, instead of measuring the level of contamination at the surface of the film 202b, the measurement may take place at the surface of a layer (not shown) covering the film 202b (e.g., a protective layer, which is similar to protective layer 9 in FIG. 1).

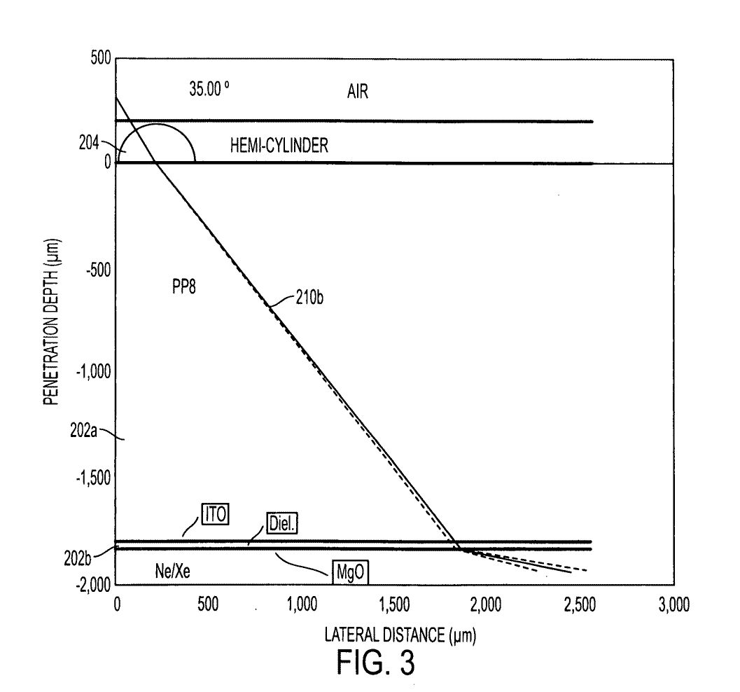

Regardless, if the incidence angle is less than the system critical angle, the infrared beam is transmitted all the way through the sample (e.g., the first hemi-cylinder IRE 204, the index matching liquid 208, the substrate 202a, and the film 202b into the rarified medium 216 beyond the lower surface of film 202b). This is illustrated for the case without a foreign IRE by infrared beam 210 in FIG. 2. The system critical angle, θc=sin⁻¹(n₂/n₁), is given by the arcsine of the ratio of the index of refraction of the rarified medium 216 to that of film 202b. In the case that the film 202b is made of dielectric glass, its index of refraction may be, for example, equal to 1.66 and its thickness may be equal to 39 μm. FIG. 3 illustrates the incident angle of an infrared beam 210b that is transmitted through the first hemi-cylinder IRE 204, substrate 202a, and film 202b without bouncing back.

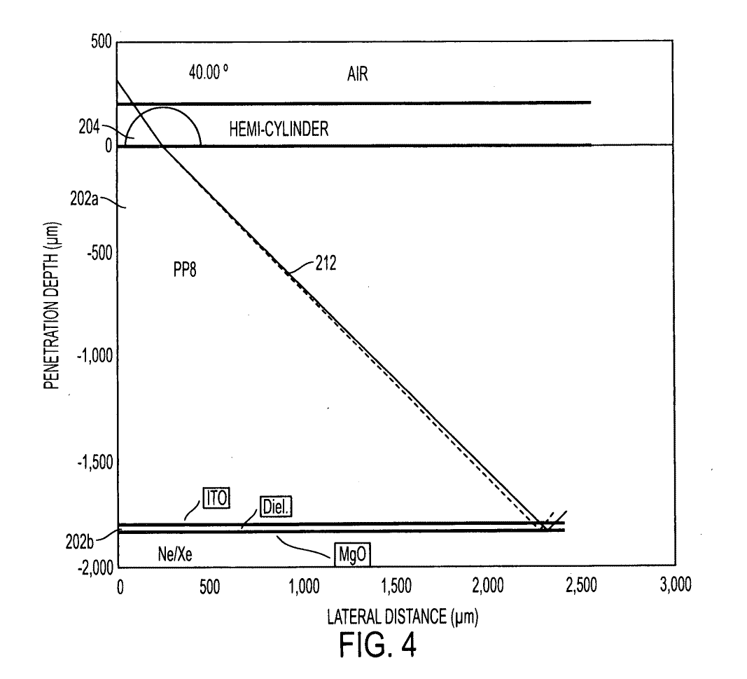

If, however, the incidence angle is greater than the system critical angle, the infrared beam is reflected off the interface between the underside of the sample (e.g., film 202b) and the surrounding environment (e.g., a Ne/Xe gas mixture). FIG. 4 illustrates, in more detail, the incident angle of an infrared beam 212 that is transmitted through the first hemi-cylinder IRE 204, substrate 202a, and film 202b and is bounced back or reflected from the bottom surface of film 202b. The internally reflected infrared beam exits the apparatus 200 through index matching liquid 208 and the second hemi-cylinder IRE 206 as shown in FIG. 2.

In one implementation, the second hemi-cylinder IRE 206 is positioned such that the reflected beam exits the apparatus 200 after one bounce, as illustrated by infrared beam 212. In another implementation, the second hemi-cylinder IRE 206 may be separated further from the first hemi-cylinder IRE 204 than that illustrated in FIG. 2. As a result, the reflected beam may bounce multiple times before it exits the apparatus 200, as illustrated by infrared beam 214 (exit coupling not shown). The multiple bounce configuration may be preferable to use because the reflected beam is coupled to the measured film multiple times, increasing the absorption signal amplitude.

Other than apparatus 200, other components of the overall system may include an FTIR bench and an optical focusing and transfer system. The FTIR bench includes a source, a detector and an interferometer and is described below in more detail. The optical focusing and transfer system, also described below in more detail, is configured to deliver the infrared beam signal to a foreign IRE (e.g., a first hemi-cylinder IRE 204 shown in FIG. 2) and collect the infrared beam signal from the same or another foreign IRE (e.g., a second hemi-cylinder IRE 206 shown in FIG. 2). All components of the overall system may possess relatively uniform optical characteristics in the band of interest. Absorption spectroscopy in the mid-IR (4,000-400 cm⁻¹) range may be used for the detection of most molecular species, including 0—H and N—H groups, inorganic compounds, and many organic compounds including polymers.

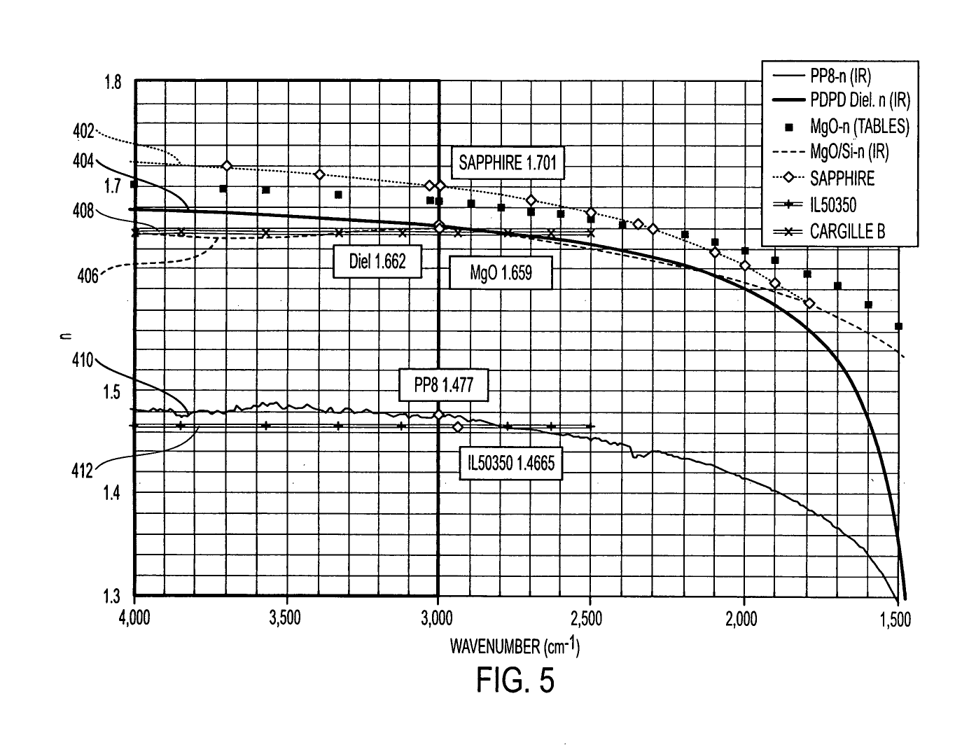

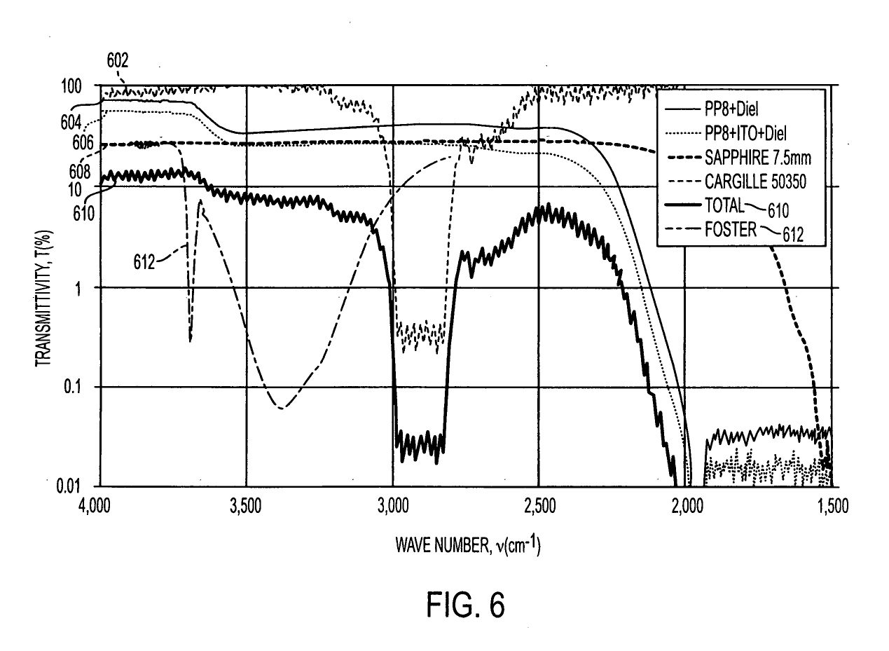

The particular compound one wishes to detect on the surface of the film (e.g., film 202b) determines the range of wavelengths of interest. For example, H₂O on MgO produces strong absorbance peaks/bands in the 4,000-3,000 cm⁻¹ range. The system components should possess uniform index of refraction and high transmittance for transparent components, and high reflectivity for reflective components, in the band(s) of interest. The index of refraction and transmittance for various materials are shown in FIGS. 5 and 6, respectively, in the 4,000-1,500 cm⁻¹ range.

Referring again to FIG. 2, the index of refraction for the first and second IREs 204, 206 should be greater than that of substrate 202a, or at least close to substrate 202a index of refraction to access a wider range of incidence angles producing total internal reflection. FIG. 5 illustrates the index of refraction for sapphire 402, PDPD dielectric 404, MgO on Si 406, index matching liquid Cargille B 408, soda lime glass PP8 410, and index matching liquid IL50350 412. As shown, the sapphire 402 has the highest index of refraction of all and the IL50350 412 has the lowest index of refraction of all. Furthermore, the index of refraction for each of elements 402-412 has a stable index of refraction in the 3,000-4,000 cm⁻¹ range, which begins to slowly decline below 3,000 cm⁻¹.

As noted above, the first and second IREs 204, 206 should also have a high transmittance and be chemically compatible with the index matching liquid 208. FIG. 6 illustrates the transmittance for various compounds (e.g., index matching liquid Cargille 50350 602, soda lime glass with dielectric glass PP8+Diel 604, 604 with indium tin oxide layer PP8+ITO+Diel 606, and sapphire 608). Among the illustrated compounds, Cargille 602 has the highest transmittance in the range between 4,000 and 3,000 cm⁻¹. However, the transmittance of Cargille 602 between about 2,800 and 3,000 cm⁻¹ is nearly zero. On the other hand, PP8+Diel 604, PP8+ITO+Diel 606, and sapphire 608 have both high transmittance and constant bandwidth.

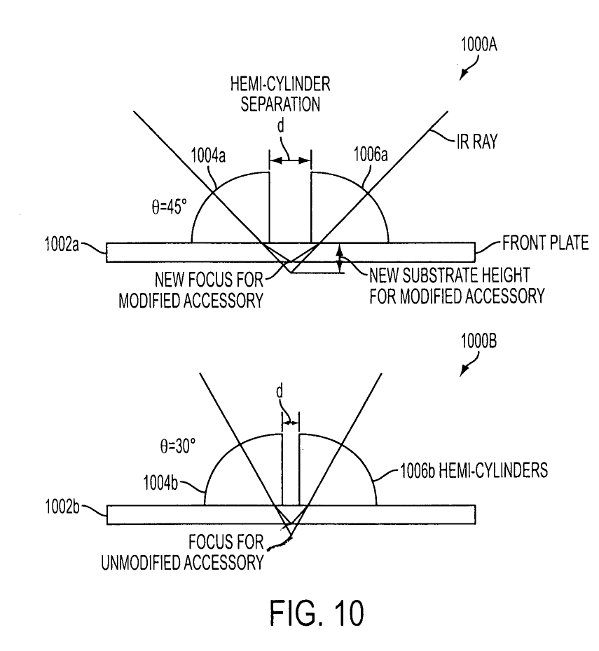

In one implementation, as shown in FIG. 2, the first and second IREs 204, 206 include a truncated hemisphere or hemi-cylinder for single-bounce and/or multi-bounce operations. In another implementation, as shown in FIG. 10, the first and second IREs 204, 206 include a near-quarter-cylinder for single bounce and/or multiple bounce operation. The first and second IREs 204, 206 may be truncated by the thickness of the substrate to reduce the infrared beam path length and hence improve transmittance through the combined foreign IREs, substrate and the film. Alternatively, a simple (non-truncated) near-quarter-cylinder is also acceptable.

In either case and as noted above, the first and second IREs 204, 206 are coupled to substrate 202a via the index matching liquid 208. The purpose of the index matching liquid 208 is to couple the infrared beam from the foreign IRE 204 into substrate 202a and to couple the infrared beam from substrate 202a into the foreign IRE 206. As a result, the ideal index of refraction for the index matching liquid 208 may be between those of the surrounding components. Minimal reflection at the interface may also be desirable. It may further be desirable that the index matching liquid 208 be non-toxic for ease of handling, and have moderate viscosity to promote uniform flow in the interface between the adjacent components. For very sensitive measurements, a means of maintaining constant pressure between the foreign IREs 204, 206 and substrate 202a may be necessary to maintain a repeatable index matching liquid thickness between these components. The constant index matching liquid thickness will produce uniform results from sample to sample because the transmission losses through the index matching liquid 208 will be repeatable.

The requirements of the substrate 202a may include restrictions on the index of refraction, transmittance, thickness, and curvature of the material. Although these substrate parameters may affect the efficacy of the method, the characteristics of the other components are usually chosen to be compatible with the substrate 202a. That is, the apparatus may be designed and built around the substrate 202a and analyte requirements. Regardless, the method may have an unacceptable signal-to-noise ratio if the substrate thickness is high and the transmittance is low.

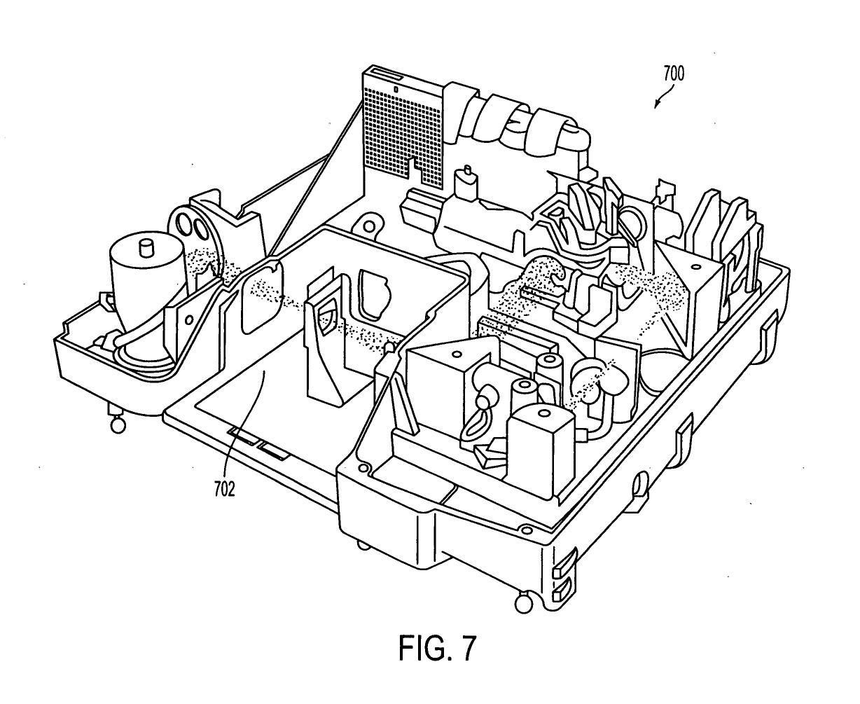

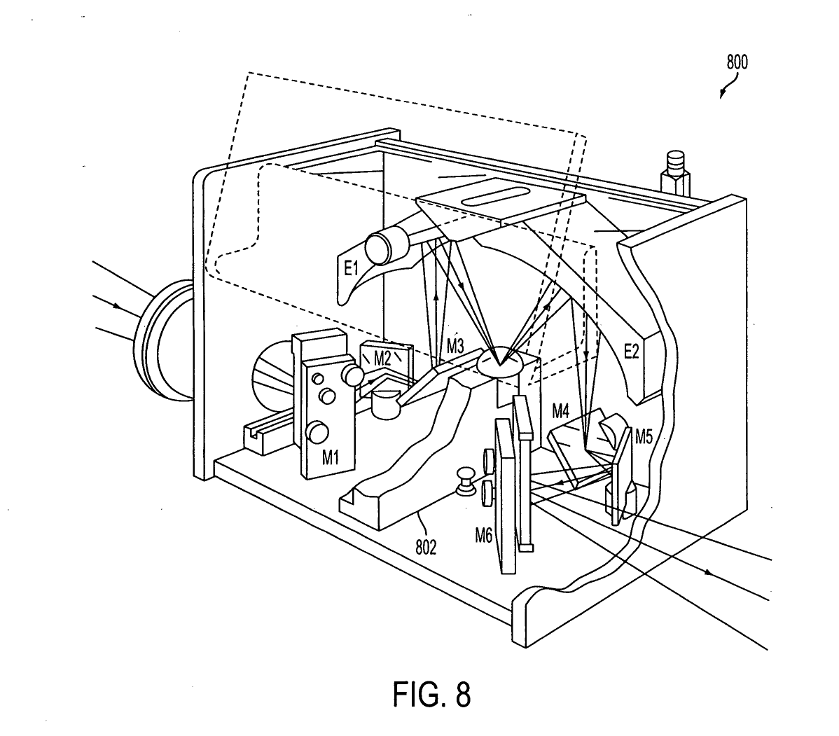

Referring to FIG. 7, in one implementation, the apparatus 200 utilizes a commercial FTIR bench 700 (source/interferometer/detector) with a sample compartment 702 to accommodate a variable angle reflectance accessory such as the one shown in FIG. 8 to direct the infrared beam perpendicular to the curved surface of a first IRE 204 (i.e., a foreign input IRE) and to collect the infrared beam emerging from the identically shaped second IRE 206 (i.e., a foreign output IRE). FIG. 8 illustrates one example of such a variable angle reflectance accessory 800 according to U.S. Pat. Nos. 5,048,970 and 5,262,845 that may be used.

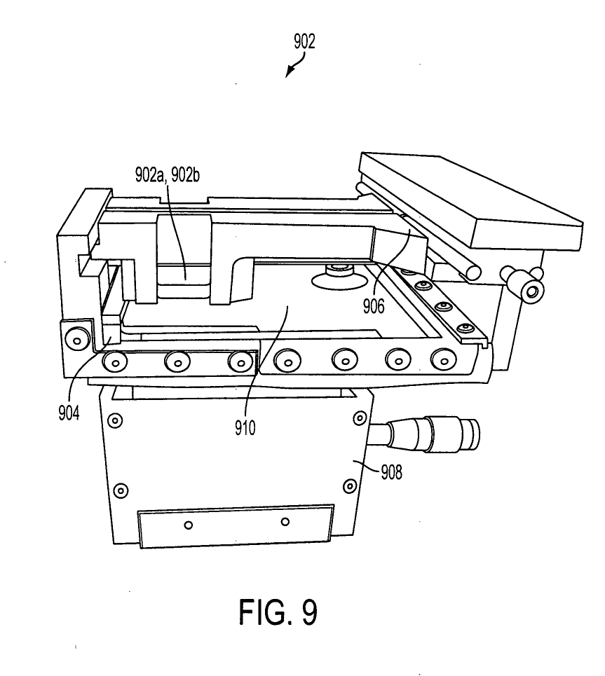

As shown, the variable angle reflectance accessory 800 includes a sample holder 802. The sample holder 802 may be replaced by an apparatus shown in FIG. 9 to accept a sealed miniature plasma display panel. FIG. 9 illustrates a sample holder 902, designed to hold miniature PDPs in the Seagull™ accessory, to apply pressure on the miniature PDP to produce a repeatable force between the PDP substrate and the foreign IREs also mounted in this device, and to position the PDP/foreign IREs to properly intersect the infrared beam at the angle set in the Seagull™ accessory. The sample holder 902 includes two sapphire hemi-cylinders 902a, 902b, a pressure bladder 904, a transverse adjustment mechanism 906, a vertical adjustment mechanism 908, and a panel 910.

Referring to FIG. 10, in one implementation, the sample holder 802 may be replaced with apparatus 902 which includes the sealed plasma display panel and foreign IREs 1000A or 1000B for purposes of measurements. Similar to apparatus 200, the assembly 1000A includes first and second foreign IREs 1004a, 1006a coupled to a substrate 1002a via an index matching liquid (not shown). The first and second foreign IREs 1004a, 1006a are near-quarter-cylinders and are separated from each other by a distance d. The distance d may be adjusted by, for example, the transverse adjustment mechanism 906.

The assembly 1000B also includes first and second foreign IREs 1004b, 1006b and a substrate 1002b. The first and second foreign IREs 1004b, 1006b and substrate 1002b are respectively similar to the first and second foreign IREs 1004a, 1006a and substrate 1002a. Therefore, for sake of brevity, these components are not described in more detail. The sample holder 902 may produce a somewhat defocused infrared beam because the sealed plasma display panel assembly 1000A will have been positioned to compensate for the fact that the new focus was on the far side of the substrate 1002a. To properly focus the infrared beam on the first near-quarter-cylinder IRE 1004a, sample holder 902 may adjust, via the vertical adjustment mechanism 908, the vertical height of the sealed plasma display panel assembly 1000A, and also may adjust, via the transverse adjustment mechanism 906, the distance d between IREs 1004a and 1006a. Similarly, the sample holder 902 may adjust the position of the plasma display panel Assembly 1000B to properly focus the infrared beam on the first near-quarter-cylinder IRE 1004b.

The focusing of the infrared beam partially depends on the system incidence angle. To illustrate, for sealed plasma display panel assembly 1000A the system incidence angle is set to 45 degrees and for sealed plasma display panel assembly 1000B the system incidence angle is set to 30 degrees. As shown, for properly focusing the infrared beam on the foreign IRE of each system, the larger incidence angle results in a larger distance d between the first and second foreign IREs 1004a, 1006a, whereas the smaller incidence angle results in a smaller distance between the first and second foreign IREs 1004b and 1006b.

The modified sample mount 902 performs several functions. It positions the foreign IREs 1004a (or 1004b), 1006a (or 1004b) by separating them transversely and lifting them vertically so that the infrared beam directed/collected by the mirrors in the Seagull™ accessory will enter/exit the foreign IREs 1004a (or 1004b), 1006a (or 1006b) perpendicular to their curved surface for various incident angles and multiple bounce configurations. Note also that the SeagullTm accessory accommodates a polarizer. An inflatable bladder 904 may also be incorporated in the modified sample mount. The bladder 904 is positioned under the sample to apply pressure on it, when inflated, to insure a uniform and repeatable force between the top surface of the substrate 1002a (or 1002b) and the foreign IREs 1004a (or 1004b), 1006a (or 1006b), with index matching liquid applied therebetween. In one implementation, a bladder pressure of 10 psi may be determined to be most suitable for repeatable results.

As noted above, in one aspect, the objective of the instant application is to measure trace quantities of water adsorbed by MgO in a PDP. To illustrate one example of such measurements obtained using the methods and apparatuses described herein, several sample plasma display panels were constructed each with varying levels of moisture intentionally deposited on the MgO film. Absorption spectra were collected with the above-described apparatus for high moisture content conditions and they were compared to a carefully prepared sample PDP with virtually no water on the MgO surface (“ultra-dry” panel). For one sample PDP, no MgO was deposited and a typical process (with low water partial pressure) was used for the fabrication.

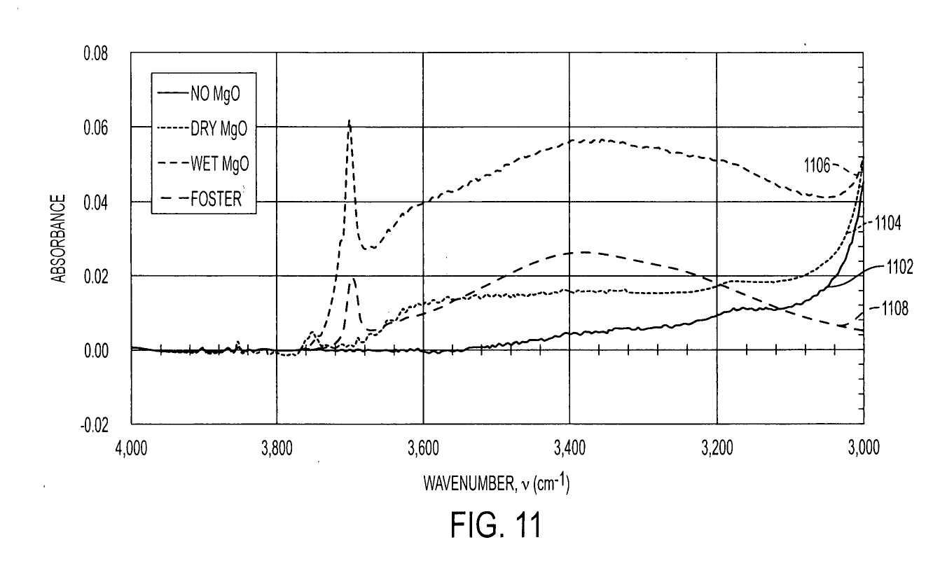

FIG. 11 illustrates absorption spectra results for three sample PDPs. The three dummy PDPs include no MgO PDP 1102, dry MgO PDP 1104, and wet MgO PDP 1106. The dry MgO PDP 1104 panel was prepared using a typical process (with low water partial pressure). The wet MgO PDP 1106 panel was prepared by exposing it to room air. The results shown are for each of these three sample panels with the absorbance for an “ultra-dry” panel subtracted.

FIG. 11 also shows the FTIR absorption spectra for MgO powder 1108 exposed to 100% RH air. See e.g., An FTIR study of water thin films on magnesium oxide,” M. Foster, M. Furse, D. Passno, Surface Science 502-503 102 (2002). As shown, the absorption spectra for the wet MgO PDP 1106 and that of the “wet” MgO powder 1108 are virtually identical except for amplitude. In the figure, the absorption peak at 3,700 cm⁻¹ is attributed to the formation of hydroxyls at defect sites on the MgO film, and the broad absorption band between 3,700-3,000 Cm⁻¹ is due to physisorbed H₂O on the surface of the MgO film.

Other implementations are contemplated. Although one example of measurements using the aforementioned method and apparatus was described above, one of ordinary skill in the art recognizes that other measurements may be performed. For example, the instant application may be utilized to investigate the dependence of the infrared beam absorbance spectra on incidence angle, number of bounces (reflections) inside the substrate, and polarization state of the incident infrared beam. Additional measurements may be performed to characterize the dependence of the absorbance spectra on the concentration of water contamination on the film encapsulated in a sample plasma display panel.

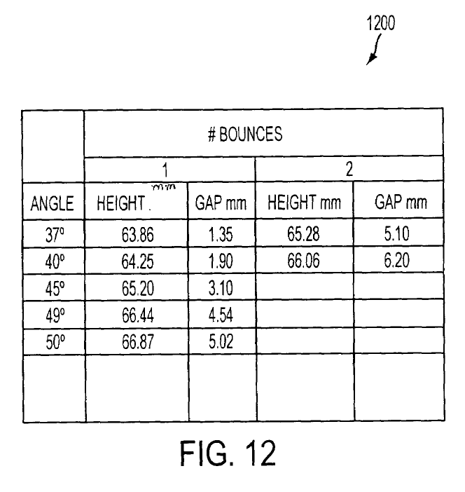

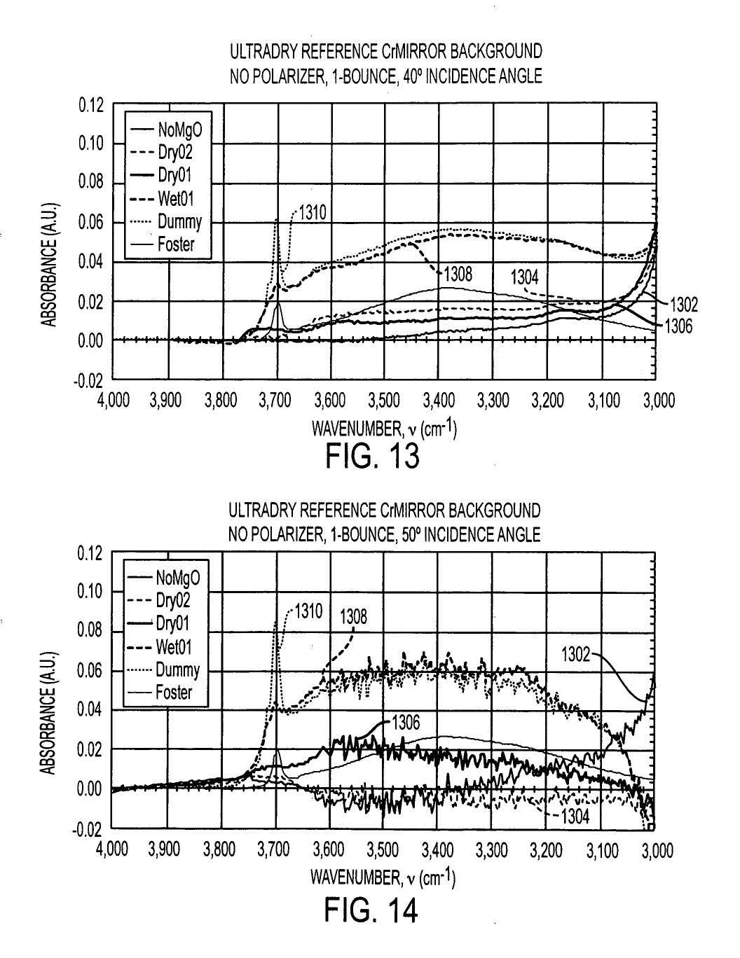

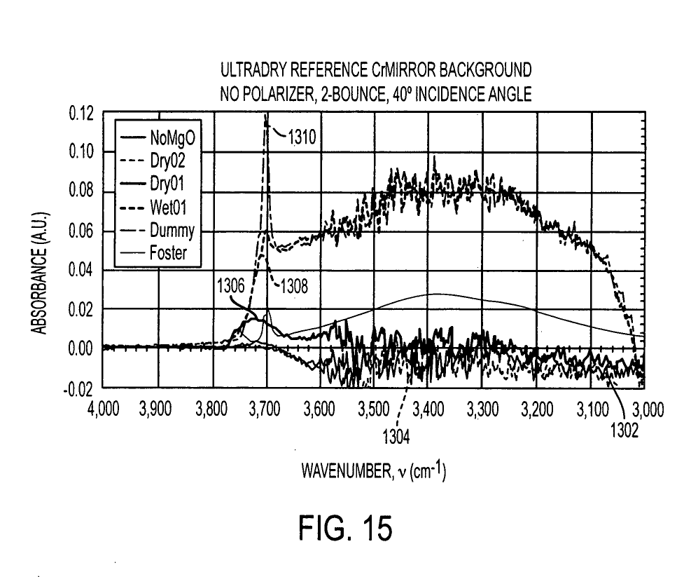

To illustrate further, FIG. 12 shows an exemplary test matrix 1200 used by the instant application to determine the dependence of absorbance on incidence angle, number of bounces, and polarization. The test was performed for a single bounce at angle 37, 40, 45, 49, and 50 degrees and for a double bounce at angles 37 and 40 degrees. Representative spectra are shown in FIGS. 13-15 for five different sample panels. In particular, FIG. 13 illustrates total internal reflection absorbance spectra for a 40 degree incident angle, 1-bounce and no polarization for five sample PDPs. FIG. 14 illustrates total internal reflection absorbance spectra for a 50 degree incident angle, 1-bounce, and no polarization for five sample PDPs. And, FIG. 15 illustrates total internal reflection absorbance spectra for a 40 degree incident angle, 2-bounce, and no polarization for five sample PDPs. The five different samples illustrated in each of FIGS. 13-15 include No MgO sample 1302, dry01 sample 1304, dry02 sample 1306, wet01 sample 1308, and dummy sample 1310. As shown, the signal-to-noise ratio suffers for configurations with longer path lengths (multi-bounce and steeper incidence angles) because of the poor transmittance characteristics of the glass substrate.

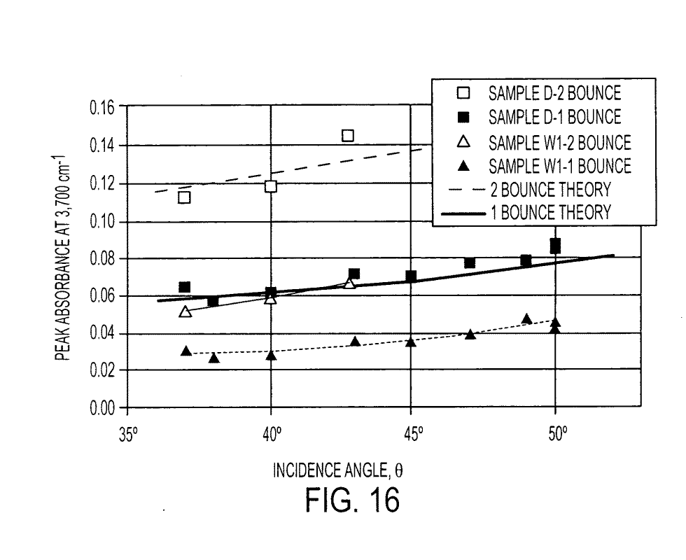

Some of the data collected according to the matrix in FIG. 12 is summarized in FIG. 16. FIG. 16 illustrates total internal reflection peak absorbance at 3,700 cm⁻¹ as a function of incidence angle and number of bounces (i.e., 1 and 2 bounces) with no polarization. The series of measurements shown demonstrate the dependence of the absorption amplitude at 3,700 cm⁻¹ for increasing incidence angle and bounce number for two different samples. In both cases, the peak absorbance is proportional to the transmission path length which is proportional to cos θ and the number of bounces. The solid line illustrates the theoretical dependence for Sample D normalized by the 1-bounce and 40 degree experimental conditions. The dashed line illustrates the theoretical dependent of Sample D normalized by 2-bounce and 40 degree experimental conditions.

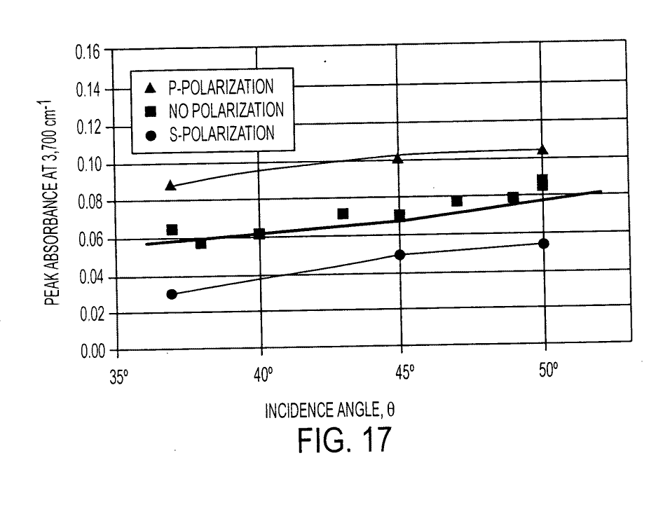

FIG. 17 illustrates total internal reflection peak absorbance at 3,700 cm⁻¹ as a function of incidence angle and polarization under a single bounce condition. The series of measurements shown determine the dependence of the absorption amplitude at 3,700 cm⁻¹ on polarization state of the incident infrared beam. The peak absorbance is found to increase by a factor of about ⅓ for p-polarization, where the infrared beam electric field is parallel with the film surface plane. The peak absorbance decreases by a factor of about ⅓ for s-polarization, where the infrared beam electric field is perpendicular to the film surface plane. This behavior is expected since the film is more fully engaged by the infrared beam when the beam electric field is in the plane of the film.

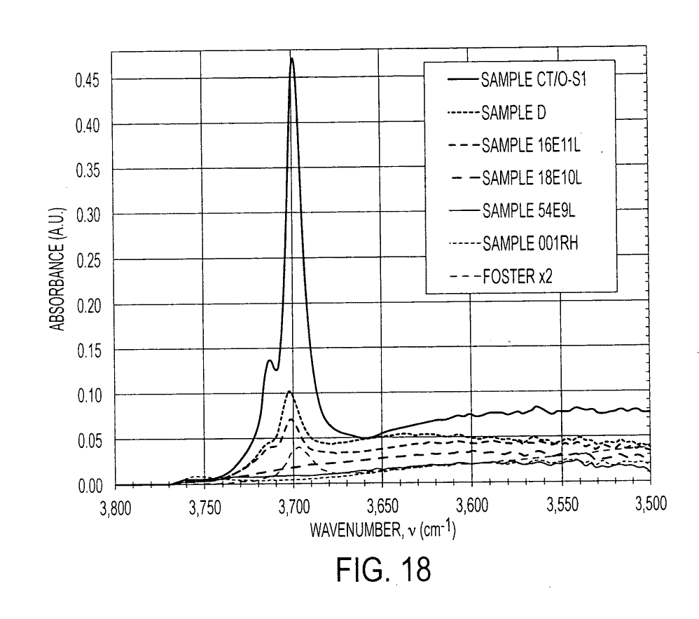

FIG. 18 illustrates absorption spectra for samples exposed to decreasing levels of water concentration for a 50 degree incidence angle, 1-bounce, and p-polarization. This figure illustrates the evolution of the absorption spectra as water concentration decreases from very high levels to the levels typical of a very dry PDP. The spectra also show the relative amplitude of secondary peaks at about 3,715 cm⁻¹, 3,755 cm⁻¹, and approximately 3,550 cm⁻¹. These secondary peaks correspond to other bonding modes in the H₂O·MgO system.

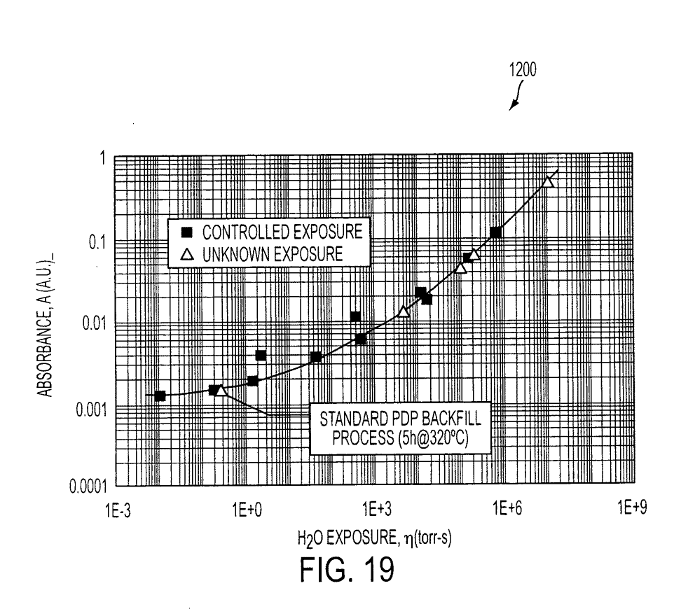

FIG. 19 illustrates peak absorbance at 3,700 cm⁻¹ as a function of H₂O exposure level for controlled and uncontrolled exposure panels for a 50 degree incidence angle, 1-bounce, and p-polarization. Peak absorbance for sample panels prepared with increasing levels of exposure to water was measured to determine the dynamic range of this technique. A sample exposure range of about 10⁻² to 10⁺⁶ torr-s produced a peak absorbance range (at 3,700 cm⁻¹) of about 1 to 100 mAU. Results for panels with uncontrolled exposure were added to the parametric curve to illustrate the detection range of 1.3 to 435 mAU over nine orders of magnitude exposure, and to show the relative exposure of about 0.26 torr-s for a PDP sample subject to standard backfill conditions.

In another implementation, a method for measuring concentration of contaminants on a film encapsulated inside a plasma display panel includes a single foreign IRE (e.g., IRE 204 illustrated in FIG. 2) instead of multiple foreign IREs. In this method, the infrared beam is transmitted through a foreign IRE into the substrate and is reflected back and transmitted out of the substrate through the same foreign IRE.

In another implementation, the configuration of the FTIR bench and sample compartment can be optimized. For the detection of trace concentrations of analytes, high output sources and sensitive detectors may be required for high signal-to-noise operation. Consequently, new or low-hours lamps may be required for maximum light intensity. Exceptional detectivity (6.4×10¹⁰ cm-Hz^{1/2}/W) and responsivity (1.2 kV/W) may be achieved with a mercury cadmium telluride (MCT-A*/CdTe) detector. This detector must be cooled to liquid nitrogen temperatures. Removal of drifting background IR absorbance spectra, particularly from CO₂ and H₂O in air is usually required and may be accomplished with a dry N₂ purge or CEM (Continuous Emissions Monitoring) air purge. The CEM air contains 82% N₂ and 18% O₂ with less than 1 ppm concentration of contaminants (CO, CO₂, H₂O, NO, etc.). A separately purged sample chamber (isolated from the FTIR bench with KBr windows) is often helpful for frequent sample changes. Although the method and system of the present disclosure has been described and illustrated in detail, it is to be clearly understood that the same is by way of illustration and example only and is not to be taken by way of limitation, the scope of the present disclosure being limited only by the terms of appended claims.

What is claimed is:

1. A method for determining composition or concentration of contaminants on a film encapsulated inside a plasma display panel, the method comprising:
applying an index matching liquid on a first surface of a substrate of a plasma display panel;
coupling a first internal reflection element and a second internal reflection element to the substrate using the applied index matching liquid;
transmitting a light beam through the first internal reflection element into the substrate and a film coupled to a second surface of the substrate to determine composition or concentration of contaminants formed on the film;
receiving the light beam, reflected back from the surface of the film, through the second internal reflection element; and
analyzing the light beam received through the second internal reflection element to determine the composition or the concentration of the contaminants on the surface of the film.

2. The method of claim 1, wherein analyzing the light beam includes analyzing the light beam to measure concentration of water on the surface of the film.

3. The method of claim 1, wherein analyzing the light beam includes analyzing the light beam to measure concentration of water at the interface between the underside of the film and the surrounding environment.

4. The method of claim 3, wherein the surrounding environment includes a Ne/Xe gas mixture.

5. The method of claim 1, wherein transmitting the light beam includes transmitting an infrared beam.

6. The method of claim 1, wherein the transmitted light beam is reflected off the interface between the underside of the film and the surrounding environment and is transmitted out through the substrate, the index matching liquid and the second internal reflection element.

7. The method of claim 6, wherein the second internal reflection element is separated from the first internal reflection element such that the reflected light beam is transmitted out after a single bounce.

8. The method of claim 6, wherein the second internal reflection element is separated from the first internal reflection element such that the reflected light beam is transmitted out after multiple bounces.

9. The method of claim 1, wherein the first and second internal reflection elements include a hemi-cylindrical shape or a hemi-spherical shape.

10. The method of claim 1, wherein the first and second internal reflection elements include a near-quarter-cylindrical shape or near-quarter-spherical shape.

11. The method of claim 1, wherein transmitting the light beam through the first internal reflection element includes transmitting an light beam through the first internal reflection element at an incident angle greater than a critical angle to enable reflection of the transmitted light beam from the bottom surface of the film.

12. The method of claim 11, wherein the critical angle is substantially equal to an arcsine of the ratio of the index of refraction of a medium below the film to the index of refraction of the film.

13. The method of claim 12, wherein the medium below the film includes a Ne/Xe gas mixture.

14. The method of claim 1, wherein the film includes a dielectric layer or a protective layer.

15. The method of claim 1, wherein the first surface and second surface of the substrate are opposite to each other.

16. A method for determining composition or concentration of contaminants on a film encapsulated inside a plasma display panel, the method comprising:
applying an index matching liquid on a first surface of a substrate of a plasma display panel;
coupling an internal reflection element to the applied index matching liquid;
transmitting a light beam through the internal reflection element into the substrate to determine composition or concentration of contaminants formed on a second surface of the substrate;
receiving the light beam, reflected back from the second surface of the substrate, through the internal reflection element; and
analyzing the light beam received through the internal reflection element to determine the composition or the concentration of the contaminants on the second surface of the substrate.

17. The method of claim 16, wherein analyzing the light beam includes analyzing the light beam to measure concentration of water on the second surface of the substrate.

18. The method of claim 16, wherein the transmitted light beam is reflected back from the second surface of the substrate and is transmitted out through the substrate, the index matching liquid and the internal reflection element.

19. The method of claim 16, wherein the transmitted light beam is transmitted into and out of the substrate via a single bounce.

20. The method of claim 16, wherein the transmitted light beam is transmitted into and out of the substrate via multiple bounces.

21. The method of claim 16, wherein the internal reflection element includes a hemi-cylindrical shape, a hemi-spherical shape, near-quarter-cylindrical shape, or near-quarter-spherical shape.

22. The method of claim 16, wherein transmitting the light beam through the internal reflection element includes transmitting a light beam through the internal reflection element at an incident angle greater than a critical angle to enable reflection of the transmitted light beam from the second surface of the substrate.

23. The method of claim 22, wherein the critical angle is substantially equal to the arcsine of the ratio of the index of refraction of a medium below the substrate to the index of refraction of the substrate.

24. The method of claim 23, wherein the medium below the substrate includes a Ne/Xe gas mixture.
